(19) United States
(12) Patent Application Publication
(10) Pub. No.: US 2026/0245468 A1
(43) Pub. Date: Aug. 20, 2026

(54) LEARNING PROMOTION SYSTEM AND METHOD OF PROMOTING LEARNING

(71) Applicant: AUTOTELICS LABS B.V., Amsterdam (NL)

(72) Inventors: Mark Taylor SMITH, Amsterdam (NL); Thinhinane LARIBI, Amsterdam (NL)

(73) Assignee: AUTOTELICS LABS B.V., Amsterdam (NL)

(21) Appl. No.: 19/160,736

(22) PCT Filed: Feb. 28, 2024
(86) PCT No.: PCT/EP2024/055081

§ 371 Date: Aug. 28, 2025

(30) Foreign Application Priority Data
Mar. 7, 2023 (NL) 2034279

(51) Int. Cl. G09B 5/02

(52) U.S. Cl. CPC G09B 5/02

(57) ABSTRACT

The invention relates to a learning promotion system, comprising: a learning promotion device with measurement means, for connecting to a workpiece and for measuring one or more parameters associated therewith, and work analysis means. Processing means are provided that a) determine, based on a model stored in a memory and the measurements, a state of the workpiece; b) determine, based on the state of the workpiece and the model, a learning intervention suggestive of an action to be performed by the participant in order to progress the work to be performed, so as to bring the workpiece to another state which is equal to or which is closer to a completed state as defined by the model; and c) control an interface to provide user output corresponding to the learning intervention. In an embodiment, means are provided that determine interactions taking place between participants and resources to perform learning analytics.

The invention relates to a learning promotion system. More in particular, the invention relates to employing learning analytics or the result of effective use of learning analytics, to promote learning.

Traditionally, the analysis of learning has been troubled with several complicating factors. As an example, it is known that students learn from e.g. their textbook or by performing practice, but also from complex social interactions with each other and/or with for example a tutor. Yet, traditional analysis techniques depend on the observation of simple student actions (e.g. how much time was spent practicing) but do not account for interactions with resources such as reference books, tools, whiteboard, and the object upon which study is performed, etc. Resources may also include human resources, such as instructors, tutors, peers, etc. The lack of input on these interactions leads to scientifically questionable results, as the interactions may differ between tests as they are typically unobserved. Moreover, by focussing on actions performed by a student, it cannot be concluded whether or not the facilities or environment offered to the student is effective in promoting learning. Finally, tests employed for determining effectiveness traditionally rely on human observation and are therefore inherently subject to subjective interpretation.

Some effort has been made in the digital space to alleviate these disadvantages. As an example, for exercises performed online, a student trail, constituting all their actions during the learning process, may be tracked by counting clicks, timing the student's efforts, etc. When comparing such trails to the progress of the student, some learning analysis can be performed objectively.

Online examples of learning analysis however still fail to solve issues related to the social context in which students learn, and may have other shortcomings. Moreover, it is as of yet questionable whether learning analytics can be extended to the physical, i.e. offline world just as objectively.

The invention therefore has as its object to address at least partially one or more of the above-stated problems.

For this purpose, the invention provides a learning promotion system, comprising a learning promotion device and work analysis means. The learning promotion device includes measurement means, for connecting to a workpiece upon which a participant, e.g. a student, is to perform a work and for measuring one or more parameters associated with the workpiece over the connection, and an interface for providing user output. The work analysis means comprise a memory for storing thereon a model of the work to be performed by the participant and processing means operatively connected to the memory and to the measurement means for receiving one or more signals indicative respectively of the one or more parameters measured, and operatively connected to the interface for controlling output of the interface. The processing means are configured to repeatedly:
a) determine, based on the model stored in the memory and the one or more signals indicative of the one or more parameters, a state of the workpiece;
b) determine, based on the state of the workpiece and the model, a learning intervention suggestive of an action to be performed by the participant in order to progress the work to be performed, so as to bring the workpiece to another state which is equal to or which is closer to a completed state as defined by the model; and
c) control the interface to provide user output corresponding to the learning intervention.

By performing measurements on the workpiece, it becomes possible to obtain information on the progress of the work to be performed. The measurement is objective, and there is no need for subjective human observation. The work analysis means allow comparison of the measurements with a model for the work to be performed so as to determine a state of the workpiece, i.e. an intermediate step of work to be performed. Based on the knowledge of that state and the model of the work to be performed, a learning intervention can be derived. The learning intervention can be given to the student, so that the student may progress in performing the work.

At this point, it is noted that the learning intervention may also be presented to other stakeholders, such as instructors, tutors, administrators, etc. These parties could use the learning interventions to infer how the learning process can be improved. For this purpose, the learning intervention may be provided to these parties in a different format and/or using a different medium.

One of the advantages of the system proposed is that the learning interventions suggested to the student can be adjusted for the particular student, for their progress, and for the work to be performed. Moreover, depending on the model of the work to be performed, effective learning interventions can be suggested even for unexpected tasks. For instance, when a student has made an unexpected error in performing work on the workpiece, the measurement may allow determining in what state the workpiece is, so that a learning intervention may be derived that solves or reverses the error.

It is noted that it is principally possible that the learning interventions form a step-by-step guide for performing the work, however in some cases this may not be the most effective in terms of learning. Instead, the learning interventions may comprise a hint or suggestion conducive to the student making progress by themselves, as opposed to an explicit instruction.

It is noted that instead of physically connecting to the workpiece, it is also possible to perform measurements on the workpiece from a distance, i.e. visually or based on some other kind of measurement. It is thus important only that the measurement means are capable of measuring the one or more parameters.

It is noted that determining which learning intervention to output effectively may constitute using the results of effective learning analytics. In particular, the effectiveness of learning interventions may have been derived by performing learning analytics. However, for the purposes of this invention it is not strictly necessary that learning analytics is applied beforehand. As an alternative, learning interventions may be listed and ranked by an expert, or may be obtained some other way.

The use of a learning promotion system is not dependent on determining which learning intervention needs to be selected, and/or on outputting it (steps b) and c)). In fact, if learning analytics is the goal, rather than promoting the learning of a particular student at a particular time, these steps may be omitted. In that case, several other uses may be found for the state of the workpiece determined at step a). As a non-limiting example, which will be elaborated below, the state of the workpiece may be used to determine whether learning strategies employed by the student, or learning facilities offered by the student, are effective.

The learning promotion system can be further improved if the interface of the learning promotion device is configured for accepting user input. Using the interface, the user can for instance request a learning intervention, provide information on progress, request prior learning interventions, etc. User input given via the interface may be used by the work analysis means, or by the learning analysis means introduced below, for instance for determining which learning intervention to output or to determine progress or effectiveness of previous learning interventions.

It is noted that user input and user output as used herein primarily refer to input to and from the participant respectively. Nevertheless other user groups may exist, such as instructors or mentors that consult a learning promotion system in use by a participant.

The learning promotion system may further include learning analysis means configured to perform learning analytics.

The learning analysis means may use the model and/or the measurement directly, or the state of the workpiece, to perform learning analytics. Learning analytics herein may refer to analysing the factors in the learning process to determine their influence therein. In particular, the learning analysis means may use the state of the workpiece and previous learning interventions for performing learning analytics, as will be detailed below.

The learning analysis means may be embodied on a server remote from the learning promotion device, but can equally well run on the learning promotion device if it is outfitted therefor. Nevertheless, it is advantageous if a remote learning analysis means is used, which communicates with the learning promotion device. The work analysis means may also be embodied on a remote server, for instance on the same server. Multiple learning promotion devices may communicate with the same server for performing learning analysis for the multiple learning promotion devices. Throughout this application, reference to a server may also mean a group of servers, either physical or virtual or both.

In order to facilitate learning analytics by the learning analysis means, it is advantageous if the processing means provide a signal to the learning analysis means that is indicative of events associated with the work performed on the workpiece, such as the determination that the work is in a particular state at a particular time, said time optionally being reflected by a timestamp provided in or with the signal provided to the learning analysis means.

Accordingly, the learning analysis means may be able to track the state of the workpiece or the progress of the work to be performed, and optionally compare it with learning strategies employed or learning interventions output to e.g. the participant.

It is noted that any data provided to the learning analysis means e.g. in the form of signals, may be logged or stored. A database of records thus achieved may be used to analyse a relatively large dataset in order to obtain more relevant results.

In particular, the learning analysis means may be configured to determine the effectiveness of a learning intervention that was output via the control interface, based on at least a state of the workpiece determined after the learning intervention has been output.

In order to do so, the learning analysis means may log learning interventions that were output, and may log the state of the workpiece, e.g. based on information from the processing means, such as the state of the workpiece and optionally the timestamp.

The learning analysis means may combine information from several learning promotion devices and/or from several uses of the learning promotion devices in order to obtain a statistically relevant result. Methods in order to do so are known to the skilled person, for instance as statistical analysis and/or artificial intelligence, such as machine learning.

A particularly advantageous system may be achieved if the learning promotion system further includes a location determination system, comprising location determination means configured to determine a location of agents and/or objects within a predetermined space, and identification means configured to determine an identifier associated with the respective agent and/or object of which the location is determined. Moreover, the location determination system is operatively connected to the learning analysis means for providing a signal thereto indicating the determined location and identifier, optionally together with a time using e.g. a timestamp.

Using the location determination system further events in the physical world can be used to perform learning analytics. As an example, the time a participant sat working at a table could be registered, or the amount a participant moved about could be registered, both as an exemplary input to the learning analysis means.

Additionally, location determination may allow analysis of relatively complex interactions, which may take place when multiple participants are close. Previously these interactions would either go unobserved, or were subject to subjective observation.

The learning analysis means may be further configured to determine an interaction takes place based on at least the determined location of at least one agent and/or object, and determine the effectiveness of an interaction with at least a state of the workpiece determined after the interaction has taken place.

Based on the location information, it may be derived a participant interacts with a resource, such as another participant, an instructor, or an inanimate resource such as a textbook, blackboard, etc. In particular, when a participant is sufficiently close to a particular resource, it may be determined that the participant interacts with that resource.

The determination that an interaction takes place may be based on the timestamp provided with the location information. Timing information derived from the timestamp may be used to determine how long an interaction took place, and when. In particular, the timing information could be used to determine whether a participant was able to make progress on the work to be performed after the interaction, which can be used as an indicator for the effectiveness of the interaction.

Each interaction may have an associated learning strategy. As an example, if the interaction entails a participant being in a group, the associated learning strategy may be to discuss the work to be performed in a group. If the interaction entails a participant consulting a textbook, the learning strategy may be to look up theory.

Learning strategies may be predefined, but can also be derived from behaviour analysed by the learning analysis means. In any case, the learning analysis means may comprise a library, such as a database, for storing learning strategies and their effectiveness. Using said database, the learning promotion system may be able to provide learning interventions based on learning strategies that have a relatively high effectiveness.

In that regard, a learning intervention may be a suggestion to employ a particular learning strategy. Optionally, the learning strategy or the learning intervention and its related effectiveness may be related to the state of the workpiece as determined by the learning promotion system.

It is advantageous if learning strategies are derived on the fly, for which purpose the learning analysis means may be configured to store the interaction as a learning strategy with its determined effectiveness in the library. In other words, when it is determined an interaction takes place, the effectiveness of the interaction may be tracked by performing measurements on the workpiece. The effectiveness and the interaction may be stored together, so that for similar situations in the future, learning interventions can be based on the fact that a particular interaction has proven effective. The learning intervention suggested can in that case be based on a strategy that likely results in the proposed interaction.

In practice, the analysis means will analyse input from multiple learning promotion devices over longer periods of time, thereby analysing a relatively large amount of interactions. The effectiveness of the interactions may therefore be derived based on multiple interactions.

A preference for certain learning strategies or types thereof may be derived from observing interactions involving a particular participant. Accordingly, the learning promotion system may enable providing participant specific learning interventions. This may include profiling a participant based on how effective past interactions have been. In cases where profiling is not desirable, a user may for instance be allowed to select a desired predefined profile when performing work.

It is noted that the process of learning is likely relatively complex. As an example, a suitable learning strategy may be to try a particular task, consult a textbook, consult an instructor, and to try again, in that order. By analysing the relatively large amount of interactions and employing statistical analysis and/or artificial intelligence, such as machine learning, relatively complex relations between interactions and effectiveness may be determined, so that learning strategies resulting in desired interactions can be derived.

It is noted that deriving interactions from location information is merely one example of perceiving interactions in order to determine a learning strategy. In practice, learning analytics can be performed as long as measurements are made that can be used to determine that a learning strategy is employed, and/or to determine that an interaction takes place. Therefore, the learning promotion system may be provided with adequate measurement means and means for deriving what learning strategies are employed based on input received from the measurement means. The derived learning strategies can be used similar to the learning strategies that were derived form location information above.

Therefore, in one embodiment, the learning analysis means are further configured to determine that an interaction takes place based on a measurement, by for instance the measurement means or some other sensor connected to the learning analysis means for providing a measurement result thereto.

In order to provide a learning intervention that is likely to be effective, the processor may be configured to, in step b), retrieve one or more learning strategies and their associated effectiveness from the library, and to determine the learning intervention based on one or more of those learning strategies.

Learning analysis may have other purposes than allowing selection of a particularly effective learning intervention. For instance, when it is determined a certain interaction is effective, an instructor may opt to focus on such interactions. Accordingly, the learning analysis performed by the current learning promotion system can be used to improve an environment in which the student learns. Further examples of improvements made based on learning analysis are e.g. the provision of more of an effective resource, planning group work, restricting ineffective strategies, promoting a particular order of strategies, etc.

For this reason, the learning analysis means may be configured to provide, based on the effectiveness of learning strategies, suggestions on improving the learning space within which participants operate.

The invention also relates to a method of promoting learning, the method comprising:
having a participant, e.g. a student, perform a work on a workpiece;
performing a measurement on the workpiece in order to obtain one or more parameters associated with the workpiece,
the method comprising, optionally repeatedly:
a) determining, based on a model of the work to be performed and the one or more parameters, a state of the workpiece;
b) determining a learning intervention based on the state of the workpiece and the model, the learning invention being suggestive of an action to be performed by the participant in order to progress the work to be performed, so as to bring the workpiece to another state which is equal to or which is closer to a completed state as defined by the model; and
c) output the learning intervention to the participant.

The invention also relates to a method of performing learning analytics, the method comprising:
promoting learning according to the previous claim; and
while the work is being performed, registering events associated with the work performed on the workpiece, such as the determination that the work is in a particular state at a particular time; and
determining the effectiveness of a learning intervention that was output to the participant, based on at least a state of the workpiece determined after the learning intervention has been output; and/or
performing measurements to determine that a learning strategy has been performed, and determining the effectiveness of the learning strategy.

The methods may further comprise performing the steps explained in relation to the learning promotion system herein.

The invention will be further elucidated with reference to the drawings, in which:

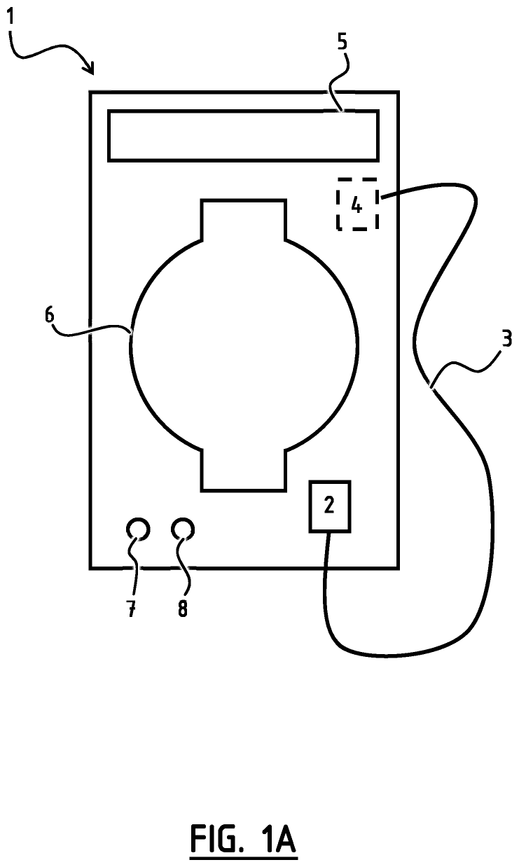

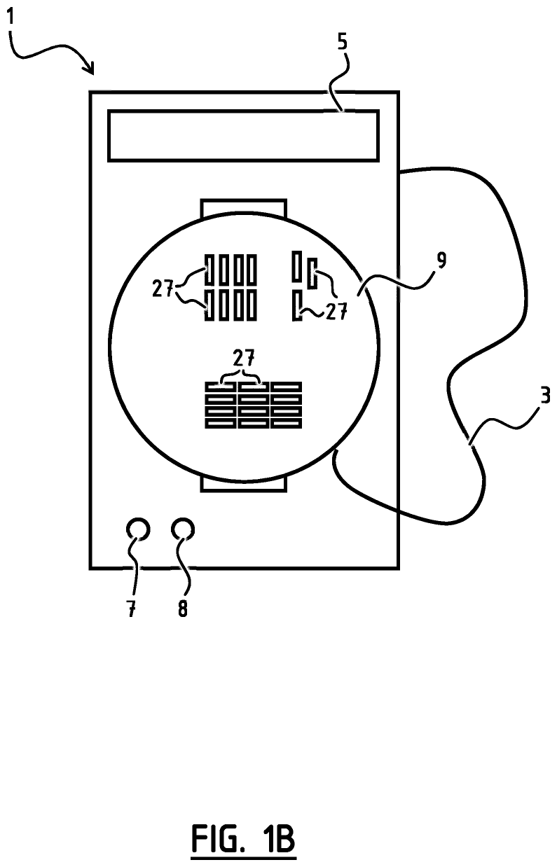

FIGS. 1A and 1B schematically show a learning promotion device respectively without and with a workpiece;

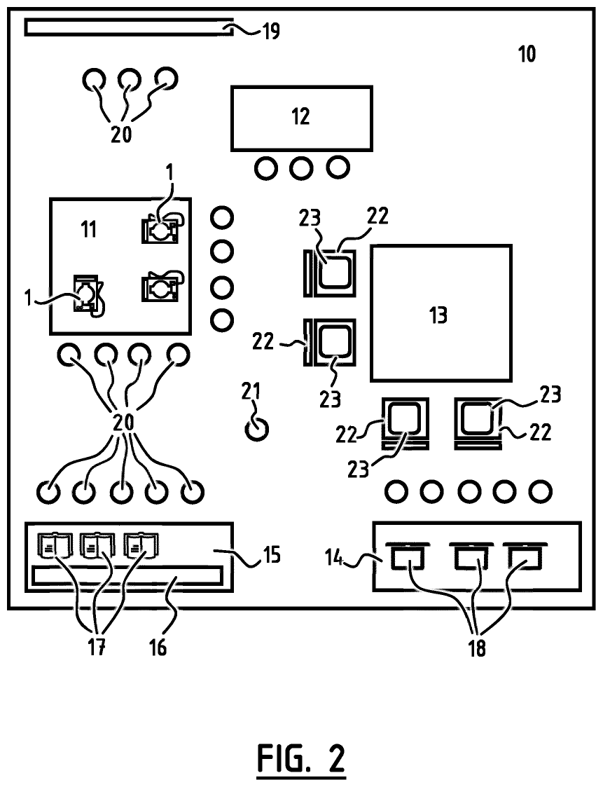

FIG. 2 schematically shows a plan view of an exemplary classroom;

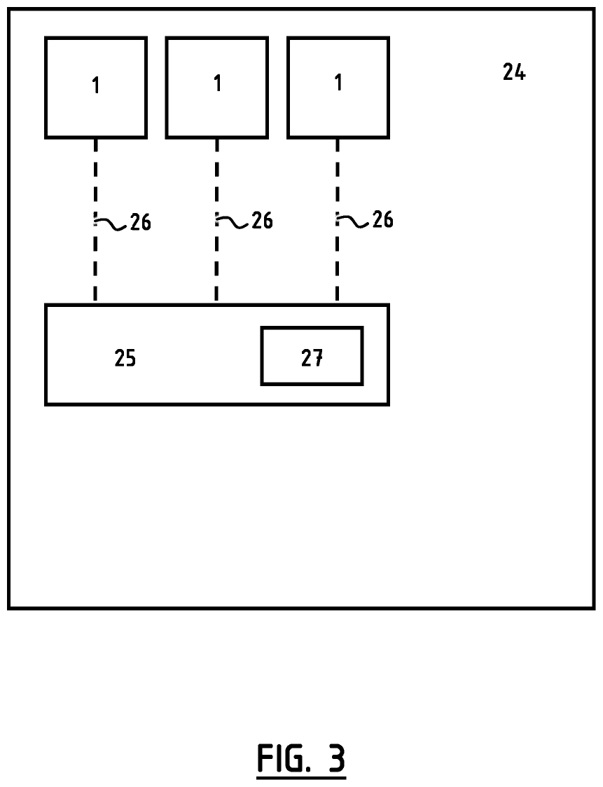

FIG. 3 shows a schematic representation of a learning promotion system; and

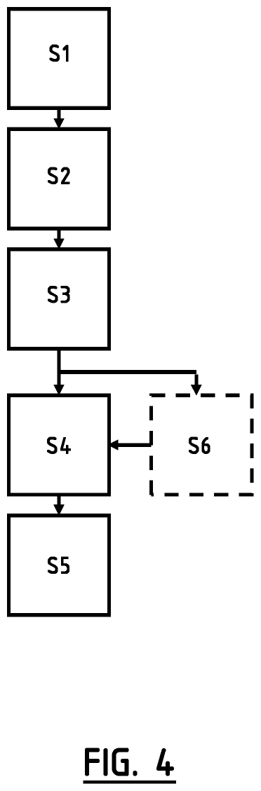

FIG. 4 shows schematically a method of promoting learning and of performing learning analytics.

Throughout the figures, like reference numerals are used to refer to like elements.

FIG. 1A shows a learning promotion device 1. The device 1 includes a connector 2 at the end of a cable 3, so that a workpiece 9 (see FIG. 1B) can be connected to the device 1. The cable 2 extends from the measurement means 4, which may include a sensor. The measurement means 4 are shown in dashed lines since they would normally be placed on the interior of the device. The device 1 further has a display 5 and input elements 7, 8, which may for instance comprise buttons, knobs, switches, etc. the display 5 and the input elements 7, 8 make up a user interface for outputting to the user and for receiving user input. It is noted that other types of user interfaces are also envisioned, such as touch-screen display, voice commanded input devices, etc. The device 1 further includes a bracket 6 for supporting a workpiece.

FIG. 1B shows the device 1 of FIG. 1A, but now with a workpiece 9 supported on the bracket 6. The connector 2 is connected to the workpiece, and is therefore no longer visible in FIG. 1B. Accordingly, the device 1 is connected to the workpiece 9 via the cable. It is noted that whilst it is advantageous to connected directly to the workpiece, it is also possible the device 1 performs measurements without a physical connections, for instance via video recording, receiving electromagnetic radiation, or some other way.

The workpiece 9 in this case is a premade circuit board, that has several components 27, which may be electric, electronic components or ports. For the sake of simplicity, not all components 27 are provided with reference numerals. In this particular example, which is not limiting, a work to be performed is to connect several components 27 to several ports 27 by soldering, thereby completing an electric circuit in order to obtain a finished workpiece 9. The premade circuit board includes a socket for the connector 2, so that the measurement means can be connected to at least some of the ports of the workpiece 9 via the cable 3 and the connector 2. Accordingly, the measurement means can perform measurements on the ports, thereby obtaining information about the state of the circuit to be completed. The workpiece 9 of FIG. 1B is of an exemplary nature only, the disclosure herein may relate to different types of exercises.

FIG. 2 shows a classroom 10 with a teacher's station 12 and student tables 11, 13. The classroom 10 further includes a reading station 15 with a book case 16 and books 17, a computer research station 14 with laptops 18, and a blackboard 19. A first students table 11 is laid out as a work station 11 where students can perform work on their workpieces 9 on a learning promotion device 1. Throughout the classroom 10, inductive sensing rings 20 are provided on or under the floor. Of course, other detectors could be used, such as capacitive sensing rings or any other kind of detector. Students can be provided with an RFID-tag that interacts with the rings 20, so that the location of a student can be determined using the rings 20. It is noted that other kinds of tags could be used, for instance RF-tags, or other suitable systems. Not all rings are provided with their own reference numeral for the sake of simplicity. Most rings are provided in strategic locations, such as near important learning resources such as the teacher's station, the reading station 15, the computer research station 14, and the blackboard 19. Using the RFID-tags and the rings 20, the location of a student may be determined. RFID-tags can be added to tutors or teachers as well. It is noted not all rings 20 need to be placed at predefined locations. As an example, a ring 21 is provided in a central location, which may be useful for tracking movements. It can readily be understood that the rings 20, 21 and the RFID-tags form a location determination system. The skilled person however understands that other methods of determining the location of students or resources may also be employed. As an example, reference is made to the second student table 13, which is surrounded by chairs 22 provided with presence detectors 23. Using the detectors 23, it can be determined whether or not someone is seated on the respective chair 22. The chairs 22 can therefore be used as part of a location determination station.

It is noted that the particular classroom of FIG. 2 is shown as an example only. The current disclosure may be applied in different kind of spaces, possibly containing different learning resources.

FIG. 3 shows a system for promoting learning 24, the system including several learning promotion devices 1, and learning analyses means 25. The learning promotion devices 1 are connected to the learning analysis means 25 via in this case a wireless connection. The learning analyses means 25 could for instance be embodied on one or more servers. The same servers could form or run work analysis means 27, which are therefore shown inside the learning analytics means. It is however also possible to provide the work analysis means 27 separate from the learning analysis means, for instance as part of each learning promotion device 1.

Using the learning promotion device 1 (FIGS. 1A, 1B), a measurement may be made relating to a workpiece 9. Using the work analysis means 27, a state in which the workpiece 9 presides may be determined. Then, the learning promotion device 1, particularly the display 5 thereof may be used to output a learning intervention. As described above, the learning intervention may be retrieved from memory, where it may have been stored by deriving it from previously successful strategies, as determined by the learning analysis means.

A method for promoting learning is shown in FIG. 4. The method comprises firstly a step S1 of having a participant perform work on a workpiece. Then, in a second step S2 a measurement is performed on the workpiece. The measurement may be performed by the learning promotion device as described herein. In a next step S3, a state of the workpiece is determined based on the measurement. This may be performed by work analysis means, for instance based on a model of the work to be performed. Once the state of the workpiece has been determined, it is possible to, in a next step S4, determine a learning intervention to aid the student. A learning intervention may be selected from several predefined or historically derived interventions, based on an expected efficacy of the learning intervention. In other words, a learning intervention may be selected that is suggestive of an action to be performed by the participant to progress in the work to be performed. Finally, the learning intervention is output in a last step S5. Of course the method may be repeated as the work progresses, so that a student is guided along the way by learning interventions.

An optional step S6 is shown in dashed lines, which may take place while the work progresses. Events relating to the workpiece or to the work performed may be registered by the learning analysis means, using the measurement means of the learning promotion device 1. These events may be used to determine whether a learning intervention that was output has been effective. As an example, a learning intervention may be determined to be particularly effective if progress is made directly after a learning intervention was given. Alternatively, learning strategies taking place may be perceived by taking measurements. The effectiveness of these learning strategies may be used in step S4 to determine which learning intervention to output. In particular, a learning intervention may be output that corresponds to a learning strategy that has been effective in the past.

Although the invention has been described above with reference to specific embodiments and examples, the invention is not limited thereto. In fact, the invention is also described by the attached claims.

1. A learning promotion system, comprising:
a learning promotion device, the learning promotion device including:
measurement means, for connecting to a workpiece upon which a participant, e.g. a student, is to perform a work and for measuring one or more parameters associated with the workpiece over the connection; and
an interface for providing user output, and
work analysis means, comprising:
a memory for storing thereon a model of the work to be performed by the participant; and
processing means operatively connected to the memory and to the measurement means for receiving one or more signals indicative respectively of the one or more parameters measured, and operatively connected to the interface for controlling output of the interface,
wherein the processing means are configured to repeatedly:
a) determine, based on the model stored in the memory and the one or more signals indicative of the one or more parameters, a state of the workpiece;
b) determine, based on the state of the workpiece and the model, a learning intervention suggestive of an action to be performed by the participant in order to progress the work to be performed, so as to bring the workpiece to another state which is equal to or which is closer to a completed state as defined by the model; and
c) control the interface to provide user output corresponding to the learning intervention.

2. The learning promotion system according to claim 1, wherein the interface of the learning promotion device is configured for accepting user input.

3. The learning promotion system according to claim 1, further including learning analysis means configured to perform learning analytics.

4. The learning promotion system according to the previous claim 3, wherein the processing means are further configured to:
provide a signal to the learning analysis means that is indicative of events associated with the work performed on the workpiece, such as the determination that the work is in a particular state at a particular time, said time optionally being reflected by a timestamp provided in or with the signal provided to the learning analysis means.

5. The learning promotion system according to claim 3, wherein the learning analysis means are further configured to:
determine the effectiveness of a learning intervention that was output via the control interface, based on at least a state of the workpiece determined after the learning intervention has been output.

6. The learning promotion system according to claim 3, wherein the learning promotion system further includes:
a location determination system, comprising:
location determination means configured to determine a location of agents and/or objects within a predetermined space; and
identification means configured to determine an identifier associated with the respective agent and/or object of which the location is determined,
wherein the location determination system is operatively connected to the learning analysis means for providing a signal thereto indicating the determined location and identifier, optionally together with a time using e.g. a timestamp.

7. The learning promotion system according to claim 6, wherein the learning analysis means are further configured to:
determine an interaction takes place based on at least the determined location of at least one agent and/or object; and
determine the effectiveness of an interaction with at least a state of the workpiece determined after the interaction has taken place.

8. The learning promotion system according to claim 3, wherein the learning analysis means are further configured to:
determine an interaction takes place based on a measurement, by for instance the measurement means or some other sensor connected to the learning analysis means for providing a measurement result thereto.

9. The learning promotion system according to claim 8, wherein the learning analysis means comprise:
a library, such as a database, for storing learning strategies and their effectiveness, wherein optionally the learning analysis means are configured to:
store the interaction as a learning strategy with its determined effectiveness in the library.

10. The learning promotion system according to claim 1, wherein the processor is configured to, in step b), retrieve one or more learning strategies and their associated effectiveness from the library, and to determine the learning intervention based on one or more of those learning strategies.

11. A method of promoting learning, the method comprising:
having a participant, e.g. a student, perform a work on a workpiece;
performing a measurement on the workpiece in order to obtain one or more parameters associated with the workpiece,
the method comprising repeatedly:
a) determining, based on a model of the work to be performed and the one or more parameters, a state of the workpiece;
b) determining a learning intervention based on the state of the workpiece and the model, the learning invention being suggestive of an action to be performed by the participant in order to progress the work to be performed, so as to bring the workpiece to another state which is equal to or which is closer to a completed state as defined by the model; and
c) output the learning intervention to the participant.

12. The method of performing learning analytics, the method comprising:
promoting learning according to claim 11; and
while the work is being performed, registering events associated with the work performed on the workpiece, such as the determination that the work is in a particular state at a particular time; and
determining the effectiveness of a learning intervention that was output to the participant, based on at least a state of the workpiece determined after the learning intervention has been output; and/or
performing measurements to determine that a learning strategy has been performed, and determining the effectiveness of the learning strategy.
